(19) United States
(12) Patent Application Publication
(10) Pub. No.: US 2014/0344683 A1
(43) Pub. Date: Nov. 20, 2014

(54) METHODS, SYSTEM AND COMPUTER PROGRAM PRODUCT FOR USER GUIDANCE

(71) Applicant: CANDAS URUNGA, ANKARA (TR)

(72) Inventor: CANDAS URUNGA, ANKARA (TR)

(21) Appl. No.: 14/254,514

(22) Filed: Apr. 16, 2014

Related U.S. Application Data
(60) Provisional application No. 61/812,746, filed on Apr. 17, 2013.

(51) Int. Cl. G06F 3/0481; G06F 3/0484

(52) U.S. Cl. CPC G06F 3/0481; G06F 3/0484
USPC 715/705

(57) ABSTRACT

Methods are provided to guide the user, in a user centered way, to let the user achieve a task by using at least one software. The methods comprise the steps of generating and implementing user guidance (UG) file. Implementation is made by highlighting (emphasizing) the UI element(s) user will interact, giving UI element interaction information and further information, for each and every step, to guide the user to accomplish a task according to UG file. Implementation may be made on one or more software (OS, application etc.). Following the guidance, user can accomplish the task easily. UG file may be generated by recording UI elements and UI element interactions and/or by programming. UG file content can be added, deleted or changed to achieve best guidance file for the task. System and computer program product that implement the methods of the present invention are also provided.

### RELATED APPLICATIONS

The present application is related to and claims priority from U.S. Provisional Application No. 61/812,746, entitled “Method, System and Computer Program for User Guidance” filed Apr. 17, 2013, with the inventor Candas Urunga, which is incorporated herein by reference in its entirety.

### BACKGROUND OF THE INVENTION

1. Technical Field

The present invention generally relates to user guidance for using software products and more specifically relates to methods, system and computer program product to provide guidance to the user, in a user-centered way.

2. Background Art

Software applications are being used by millions of people every day. Software applications enable users to accomplish many tasks with them and each task requires a different way of interacting with the user interface (UI) elements of software applications which may be part of software applications and/or hardware.

For accomplishing any task in software environment, users can benefit from help systems, tutorials and even computer assisted self-training packages. Also there is a growing trend for training by following online video tutorials. However, a user has to display both application and help material side by side and follow the visual and/or audial information while trying to accomplish the task. This can cause distraction and fatigue which may lessen the efficiency. Also wizards are available but they help to accomplish a task usually by using another interface with limited functionality, and hence not natural.

In some games there are tutorials which show the next step in the real game environment to ensure quick and effective learning of the game play by the user. For some applications other than games, similar tutorial solutions are also available. Drawbacks of these solutions are that each of these tutorials is specific to the application and usually programmed for only a few number of tasks.

Other two solutions in the prior art for user guidance problem are macro recorders and action recorders. Said recorders can record the steps of a task from start to finish and play the process with limited or no user interaction. They fully automate the process which is not practical for most of the tasks. Similarly test automation applications are developed for automating the tests for software verification and validation, not for guiding the user.

The present invention seeds from the drawbacks of current solutions and the fact that even though accomplishing some tasks in software may seem complicated; they consist of simple and countable user interactions. Invention describes a solution that can work on almost any software and their related hardware, for accomplishing any task.

### BRIEF SUMMARY OF THE INVENTION

Main objective of the present invention is to guide the user, on one or more software, in a natural way, to accomplish a task. It overcomes problems and limitations of existing systems previously emphasized.

The present invention is performed by highlighting the UI element(s) that user will interact, giving UI element interaction information and further information. The present invention has UI element and UI element interaction recognition capability.

The present invention is generic; it can work on virtually any environment that has a UI. For example, the invention can guide the user; to design a complex 3D model in a workstation, to adjust settings of a mobile phone, to write an article on Microsoft Word™ and then send it by attaching to an e-mail with Gmail™ by using Google Chrome™ browser, to read the recommended sections of an e-book on a tablet, to fill a web form in a laptop and even to push the illuminated buttons of a controller of a machining center to perform a task, etc.

The present invention can make a paradigm shift in human computer interaction (HCI) and hence IT world since it proposes solutions to major problems of HCI. To accomplish a task, users will not have to learn or remember anymore which UI elements will be interacted, interaction sequence of them and how to interact with them. Without dealing with said problems, users can concentrate only on the task, not on the interaction issues. The present invention can also enhance speed and correctness of the interaction. Maybe more important than these, it enables utilization of the functions proactively, otherwise passively waiting to be discovered. Also by further information that can be given by the embodiments of the present invention, users can increase their knowledge related with the task.

User guidance files about any task can be shared over the Internet for the usage of all the users.

These and other features of the invention will be more readily understood upon consideration of the attached drawings, detailed description of the invention and those drawings, a preferred embodiment and other embodiments of the invention.

### BRIEF DESCRIPTION OF THE DRAWINGS

“Methods, System and Computer Program Product for User Guidance” realized to fulfill the objectives of the present invention is shown in the figures attached, in which:

FIG. 1 shows a sample system that facilitates the invention.

FIG. 2 shows a sample basic flow diagram of User Guidance (UG) file generation.

FIG. 3 shows a sample basic flow diagram of UG file implementation.

FIG. 4 shows a sample detailed flow diagram of UG file generation.

FIG. 5 shows a sample detailed flow diagram of UG file implementation.

FIG. 6 shows a sample screen capture of a UI window of a calculator application where button “2” is highlighted in the preferred embodiment of the invention.

FIG. 7 shows a sample screen capture of a UI window of a calculator application where button “+” is highlighted in the preferred embodiment of the invention.

FIG. 8 shows a sample screen capture of a UI window of a calculator application where button “3” is highlighted in the preferred embodiment of the invention.

FIG. 9 shows a sample screen capture of UI window of User Guidance Application.

### DETAILED DESCRIPTION OF THE INVENTION

The present invention is a computer-implemented invention which means that implementation of invention involves the use of a computer, computer network or other programmable apparatus. The invention has features which are realized by means of a computer program.

In the preferred embodiment, the present invention is capable to guide for task(s) that require one or more software (Operating System (OS) or application etc.).

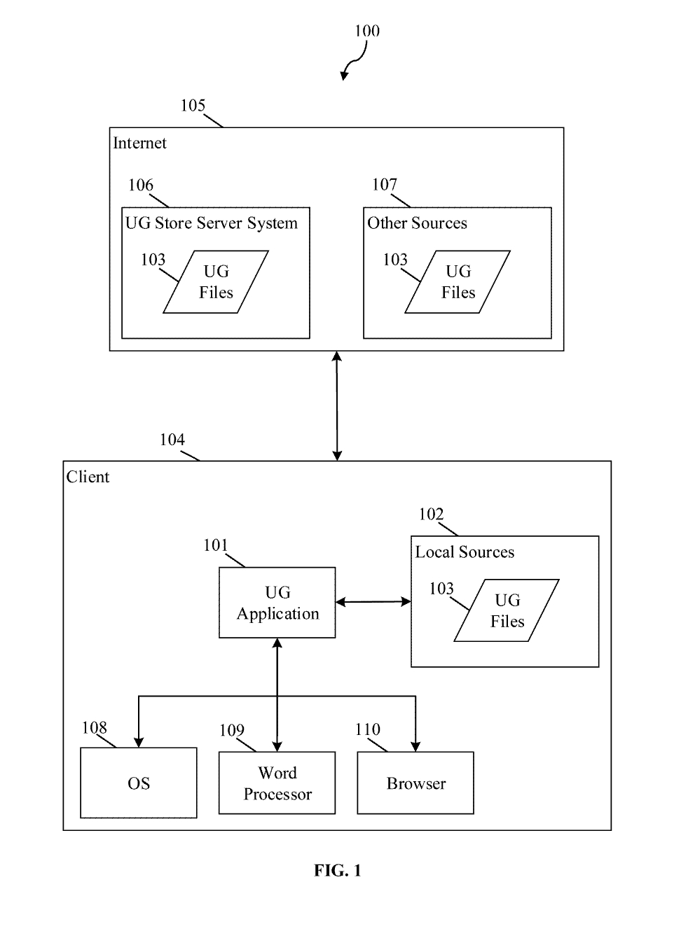

The present invention is explained in more detail with embodiments illustrated in FIG. 1 to FIG. 9.

FIG. 1 shows a system 100 that facilitates the present invention. UG application 101, in which a UI automation framework is used by a preferred embodiment, basically allows user to generate and/or implement a UG file 103 that stores the data related to user guidance instructions generated and/or implemented by UG application 101 and can search UG files 103 for the desired task to be achieved, through UG store server system 106 on the internet 105, other sources (web servers, etc.) 107 on the internet 105 and local sources (hard disks, USB flash drives, etc.) 102. In the preferred embodiment, UG application 101 can connect to a UG store server system 106 on the internet 105. UG files can be uploaded from the client 104, on which the UG application runs and local sources and necessary hardware to run UG application and interact with user exist, to the server system 106 and downloaded from the UG store server system 106 to the client 104. Also UG files 103 can be saved or opened locally. Also features like; favorite, like, comment, share, update, create playlist, intelligent playlist, subscribe to UG files, etc. can also be employed in the system. In the preferred embodiment, UG application 101 has some similarities with ITunes™ application and UG store server system 106 has some similarities with ITunes Store™ or YouTube™ that has an architecture which contains servers, databases, etc. In other embodiments, network can be a local network or peer to peer network, etc. Also in some other embodiments UG application can only access to UG files locally with no features to connect to a store or other sources. In the preferred embodiment, UG application is capable to guide for task(s) that require one or more software, such as operating System (OS) 108 on which the UG application runs, a word processor 109, a browser 110 etc. UG application interacts with OS for generation and implementation of UG files. Word processor and browser are examples of software applications for which UG files are generated and implemented by UG application. UG application can interact with software applications and OS via their UI elements.

In the preferred embodiment, UG application runs on a computer which may consist of any type of suitable processor, memory, hard disk, motherboard, wireless modem, power supply, display, keyboard, system chassis and mouse. Other embodiments are possible where the UG application can run on a mobile phone, tablet computer, a smart TV or a network of computing systems, etc. UG application can be run locally or remotely.

In the preferred embodiment, UG application is used by a single user (human agent or software agent). In other embodiments UG application(s) may be used by a single or multiple users.

In the preferred embodiment, UG application is made for multitasking OS such as Windows 7™. In other embodiments UG application can be made for any type of OS (distributed OS, embedded OS, mobile OS, etc.) that supports a UI.

In the preferred embodiment, both generation and implementation of UG files can be accomplished by one application. In other embodiments they can be utilized by different applications.

In the preferred embodiment, UG application does not require any software other than the OS to run. In other embodiments it can be a part of an OS, a part of an application or can be a plug-in or add-on, etc. Also an OS can be developed for UG.

In the preferred embodiment, UG application is a client side application. In other embodiments it can be server or cloud based application, etc.

In the preferred embodiment, UG application is delivered by downloading over the internet. In other embodiments it can be delivered by Software as a Service (SaaS) model where UG application could be accessed through a browser or thin client, etc.

In the preferred embodiment, updates of the UG application can be made on user demand. In other embodiments updates can be automatic, etc.

In the preferred embodiment, a menu bar which contains File, Edit, Insert, Format, Help menus, a search textbox and search button, record, play and stop buttons, a list box for listing search results, another list box for showing information about the steps of the UG file, etc. can be found in the UI of UG application. All the important buttons such as record, play, etc. have keyboard shortcuts. In other embodiments, UG application may have different presentations (menus, buttons, list boxes, etc.), different content and different functionalities (first step, previous step, next step, last step, etc.).

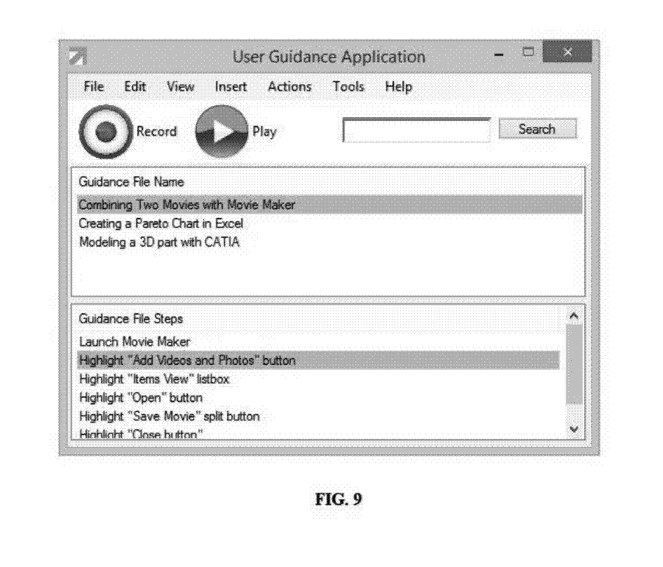

FIG. 9 shows a sample screen capture of UI window of UG application.

In the preferred embodiment, UG application UI automatically minimizes to bottom of the OS UI to record without any obstructions while recording or to guide the user without any obstructions while playing (UG file implementation). For maximizing the UG application UI, user can click to the tab of UG application on the taskbar. In other embodiments UG application UI may become very small, may hide to bottom, may become transparent, etc. User can perform different interactions to make the UG application UI visible. It can be visible by dragging upward from bottom of the OS UI or it can show up automatically when mouse pointer is on bottom of the OS UI, etc.

In the preferred embodiment, UG file generation and implementation is on a graphical user interface (GUI) interacted with a keyboard and a mouse. In other embodiments UG file generation and/or implementation can be executed on any kind of UI; a GUI interacted with a keyboard and a mouse, touch UI, audio UI, etc. or mixture of them. Any suitable hardware or software or mixture of them can be used for execution of the invention. As an example UG file generation can be done on a GUI with a keyboard and a mouse and UG file implementation can be done by both highlighting the UI elements on GUI and highlighting the keys of mouse and keyboard (having a keyboard and mouse with illuminated keys) and giving information about interaction and further information by voice, for each step.

In the preferred embodiment, UI element and UI element interactions can be discovered, identified and recognized (recognition capability) and UI element interactions can be performed (interaction capability) by using an available UI automation framework (such as Microsoft UI Automation™) in the UG application. UI automation frameworks provide programmatic access to UI elements. Said frameworks or similar ones are capable of recognizing UI elements which means that UG application is capable of recognizing the UI elements of any software. Said frameworks or similar ones are capable of interacting with UI elements which means that UG application is capable of interacting with the UI elements of any software. In other embodiments other codes, frameworks or technologies can be developed or used in the UG application. Recognition and interaction capabilities may also include hardware and other software (image recognition software, etc.).

In the preferred embodiment, output of UG generation and input of UG implementation is in the form of file. In other embodiments instead of file, other formats (signals, etc.) can be output of UG generation and input of UG implementation.

In the preferred embodiment, generation and implementation options (thickness of the highlight, show/no show further information, etc.) can be adjusted in the UG application.

In the preferred embodiment, UG application can be opened by clicking the icon of the application on the desktop. UG application can also be opened by other methods such as clicking the icon on the taskbar, etc.

### Generation Basics

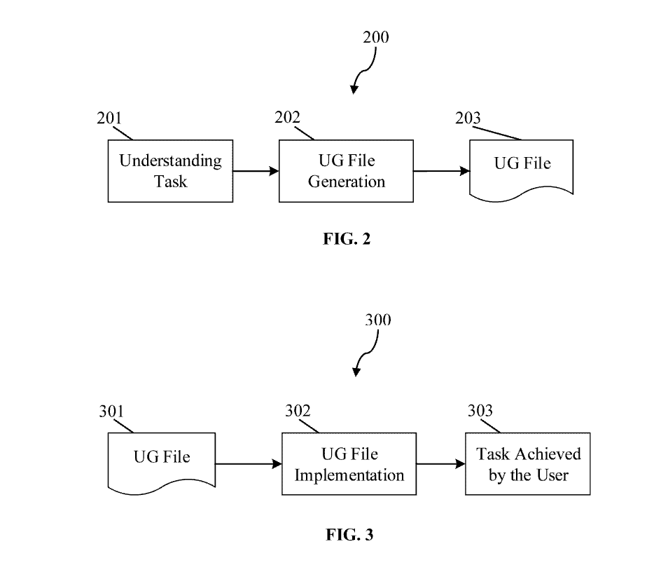

FIG. 2 shows a sample basic flow diagram of UG file generation 200. Understanding task 201 describes a step that is conducted by the entity that perceives and understands the task that should be achieved. Generating UG file 202 can be performed by methods such as recording, programming, web service composition methods, probabilistic approaches, AI planning methods, etc. or mixture of them. In the preferred embodiment, UG file is outputted 203 in the form of data file. Said data file includes UI element and UI element interaction information and further information. In other embodiments it may be an executable file, etc. and implementation may occur directly on the OS, so UG file implementation capability may not exist in the UG application.

In the preferred embodiment, one UG file can be generated. In other embodiments more than one file can be generated with batch processing, etc. at step 202.

In the preferred embodiment, understanding task 201 is accomplished by human. User performs recording by clicking record button of UG application. UG application sequentially records all of the UI elements and UI element interactions while achieving a task. After recording, if required, user can edit the recorded information by UG programming and finally UG file is generated. In other embodiments understanding and UG file generation can be employed automatically by software agents, etc.

In the preferred embodiment, UG file can be in the form of XML format and its file extension is “.gui”. In other embodiments UG file extension can be “.exe”, etc.

In the preferred embodiment, UG file is generated substantial amount of time (minutes, hours, etc.) before UG file implementation. In other embodiments file generation can be triggered with the implementation request and automatically generated within microseconds. Also in some other embodiments, instead of UG file, UG data can be generated and allocated in the memory of the computing device on which UG application runs as an input for UG file implementation.

### Implementation Basics

FIG. 3 shows a sample basic flow diagram of UG file implementation 300. In the preferred embodiment, UG file is taken as the input 301 of UG file implementation. UG file can be stored in the local hard disk, servers on the internet, etc. User can open it by various methods such as by selecting from the list on the UI of UG application, with an open file dialog, by double clicking the file at the OS location, etc. Implementing UG file 302 occurs by clicking play button and the user follows the guidance by performing interactions on highlighted UI elements and achieves the task 303. When the task is achieved by the user, UG file implementation ends. One or more UG files can be implemented serially during UG file implementation.

In the preferred embodiment, according to search results to achieve desired task, selected UG file is downloaded from UG Store to the library of UG application. After that, user selects the UG file from the list and press play button. UG application guides the user to perform a task according to UG file by highlighting the UI element(s) user will interact, giving UI element interaction information and further information, for each step. UI element interaction information can be given mainly for explaining the required action that will be executed on the highlighted UI element (left click, right click, etc.). Further information can be given mainly for explaining the meaning of the step. These explanations can be audio files, video data, etc. After the task is accomplished, user may exit UG application.

### Details of Generation

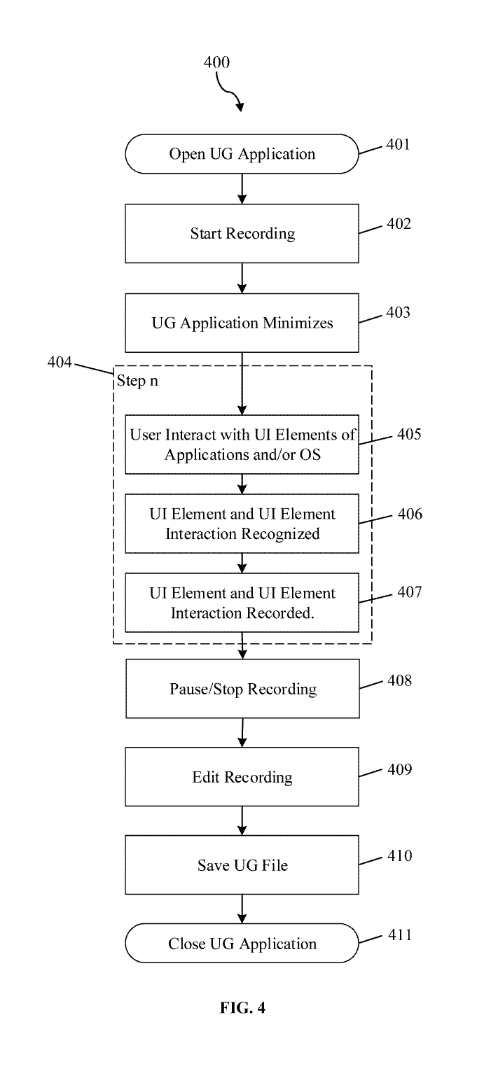

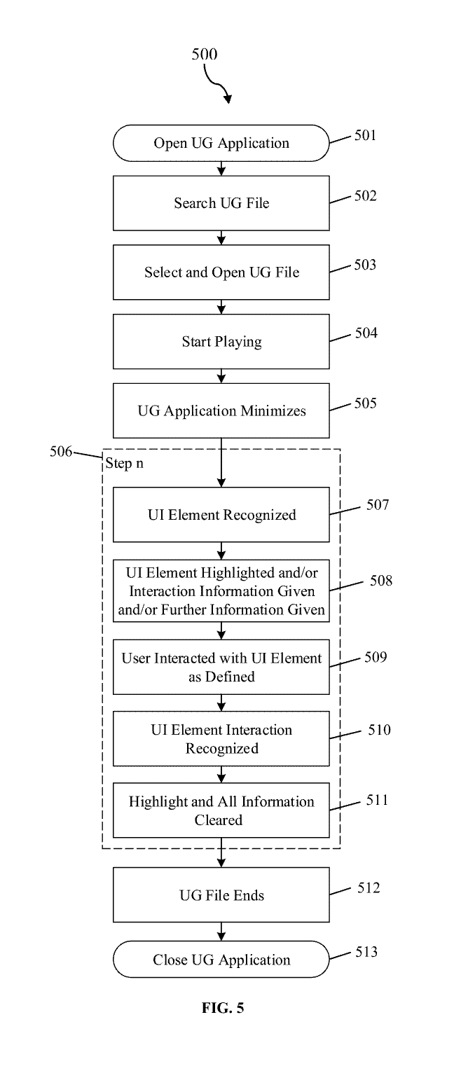

FIG. 4 shows a sample detailed flow diagram of UG file generation 400. UG file generation can be thought as a result of both recording and UG Programming for this sample.

In the preferred embodiment, generation includes all features for generating UG file for achieving any task desired with the available application(s). In other embodiments generation can be limited (only recording feature may be included, etc.) and UG file can be prepared only for some tasks.

For UG file generation, user opens UG application 401 by clicking the icon on the desktop of the application. UI of the UG application opens. User clicks record button and starts recording 402 UG file. Recording UG file 402 means the recording of UI element and UI element interaction information. In preferred embodiment of the invention, recording UI element and UI element interaction is conducted by using the capabilities of a UI Automation Framework. After the step 402, UI of the UG application minimizes 403 to bottom of the OS UI. User can interact with UI elements of applications and/or OS 405 to achieve the desired task. In exemplary embodiments of the invention, said task can be “sign in to Gmail™ and then send an e-mail” or “model a three dimensioned structural part of an aircraft with CATIA™”, etc. User interaction for achieving the task can contain one or more steps 404. Every time user interacts with a UI element, UI element and interaction are recognized 406 by UG application and then recorded 407. This means that steps 405, 406 and 407 can be repeated for “any number” times in an embodiment of the invention during the execution of UG file generation 400. These recorded UI elements and UI element interactions data are listed as steps in a list box of the UG application during recording and/or recording has finished. When the user achieves the task, UI element and UI element interaction are recorded 407 for the last step 404. Then user maximizes UI of UG application by clicking to the tab (this interaction is not recorded) of UG application on the taskbar and pressing the pause/stop button 408 (this interaction is not recorded) on the UI of UG application. User then edits the recording 409 if desired. Editing is performed by using UG Programming capability of the UG application and this capability is described in detail below. Generation of the UG file is assured by pressing “Save” button on “File” menu 410. Save dialog opens and asks file name, type, location, etc. After saving UG file, UG application can be closed 411 or preferably a trial can be made for verification by implementing the generated UG file.

In the preferred embodiment, UG file can be uploaded to UG Store for the general access for the internet users. In other embodiments it can be stored locally, on a network of computers, etc.

For some tasks, generating UG file by recording may be enough. There would be times user would like to edit recorded file by UG programming capability of UG application to generate a UG file for the desired task.

User can also create a new UG file by clicking File then New.

### UG Programming

By UG programming, any UG file can be generated for any task to be achieved. All programming basics; sequence or carrying out a process, iteration or looping, selection or decision taking can all be accomplished by the UG programming. Aim is creating a complete UG file for the desired task easily. UG programming allows user to not just make a record with UI elements and interactions data but also edit the said record and make it perfectly compatible for specific tasks.

In the preferred embodiment, UG programming provides a GUI for programming, without knowledge of programming or scripting languages. Also an editor can be available. In other embodiments UG programming can be employed to generate UG files by using a new language developed for UG or by using existing programming languages, etc.

In the preferred embodiment, UG application includes all UG programming features listed below. These features have their UI elements and UI interactions to program the UG file. For example steps on the list box may be represented with buttons that can be dragged and dropped. Most features can be employed by context menu that appears by right clicking when the cursor is on the selected step(s). Selected step(s) can be deleted, cut, copied and pasted, etc. UG programming can contain lots of other programming features but the aim of this document is to describe the present invention clearly, not to explain all details of a programming language.

In other embodiments UG file is generated by only recording, by using only some of the features in the UG programming features listed below, by some other features, etc.

### UG Programming Features

In the preferred embodiment, UI Element and/or UI Element Interaction and/or further information of a step can be added, changed or deleted or a whole step can be added or deleted. In an exemplary embodiment of the invention, user can add a video data as further information to a step.

In the preferred embodiment, order of the steps can be determined. For example user can switch the step 1 with step 2 by drag and drop on the list box. So step 1 becomes step 2 and step 2 becomes step 1.

In the preferred embodiment, quantity (one, a specific number or any number) of the repetition of step(s) (one, a group of steps or all steps) can be determined. Selected step(s) can be right clicked and from the context menu quantity of repetition can be determined. “Any number” repetitions require user to give an end signal to imply that “any number” step(s) are ended and so UG application can guide the user to the next step according to UG file. In the preferred embodiment, UG application adds an end signal button to the highlight of the UI element. Then by pressing this button, UG implementation advances to the next step according to the UG file. Text entry to a textbox can be given as an example. If the quantity of repetitions is selected as “any number” for that step, user can enter any number of characters desired but an end signal should be given to the UG application so it can guide to the next UI element. If more than one “any number” conditions coincide on a step, end signal buttons can be increased according to number of the “any number” condition. For example there can be two “any number” condition coincide on a step and pressing first end signal button may imply first “any number” condition is ended, pressing second end signal button may imply both first and second “any number” condition is ended, etc. In other embodiments instead of end signal button, UI elements in the next step can be highlighted. Also as another feature; in order to select all steps of a task, UG file name of the task can be right clicked and from the context menu its quantity of the repetition can be determined.

In the preferred embodiment, type of the UI element(s) (one element, a specific set of UI elements or all UI elements) can be determined. UI element(s) can be on software and/or hardware which means UG application can generate UG files for not only UI elements on a GUI of a software application but also UI elements of hardware of the device on which the software application runs. For example at a step, user can determine numbers 0 to 9 may be pressed on a calculator UI. User right click the step and from the context menu choose type as “specific set of UI elements” and after that select 0, 1,2,3,4,5,6,7,8,9 buttons on GUI and 0, 1,2,3,4,5,6,7,8,9 keys on the keyboard and confirm. In the implementation, at that step, all of these buttons on the GUI and all of these keys on the keyboard (a keyboard with illuminated keys) highlighted to guide the user. Semantic grouping of the UI elements to simplify making selections can be employed in the UG application. If there are multiple highlighted UI elements, UI element interaction and/or further information can be given in a suitable location nearby highlights by the UG application.

In the preferred embodiment, other guidance routes (branches) can be added to any place of the flow(s). As an example, a UG file can be generated that consist of three branches for three browsers (Chrome™, Explorer™ and Firefox™). In the first step of the UG file implementation, all of the shortcuts of the browsers can be highlighted and according to the user selection, UG application can continue to the one of the branches.

In the preferred embodiment, one step or group of steps of UG files can be used in other UG files. Also UG files can be combined as branches or sequentially to form UG assemblies which are also UG files. Modular use of UG files and UG file steps increases usability of the invention.

In the preferred embodiment, equivalent order steps can be determined. Determination can be made by grouping and indicating them as equivalent. Entering information on a form can be given as an example. In an exemplary embodiment of the invention, entering name might be step 1 while entering surname is step 2 and entering phone number is step 3. If the order is not important, these steps can be determined as equivalent order steps. Making these steps equivalent order does not change the initial implementation order. Assuming these steps are determined as equivalent order, if the user enters name textbox and clicks end signal button (step 1) UG application highlights surname textbox (step 2) but if the user accidentally clicks phone number textbox (step 3) instead, phone number textbox (step 3) will be highlighted. If user continues and enters phone number textbox and clicks end signal button (step 3), UG application highlights surname textbox (step 2). So UG application dynamically adjusts order of equivalent order steps during implementation and gives no unnecessary feedback.

In the preferred embodiment, steps can be automated to provide partial or full automation. It means that some or all steps of UG file can be automatized. UG application has the previously mentioned recognition and interaction capabilities that completely support automation. For example if a guidance would like to be generated that includes steps to fill a textbox with a determined word, automation of these steps may be more suitable then guiding the user to fill the textbox letter by letter. These steps can be automated by selecting steps, right click and select automate in the context menu. In the preferred embodiment, highlighting, etc. can be implemented for the steps that require user interaction (not for automated steps). Full automation is possible but it is not the aim to use the UG application like a state of art automation application. Partial automation would be very beneficial in some situations.

In the preferred embodiment, UI element and UI element interaction can be assigned to one or more UI element(s) and UI element interaction(s). For example in a step, in order to left click a mouse button on a UI element, user can also assign key press of a key on the keyboard, etc. to advance in the task and move to the next step. By pressing that key, UG application actually performs interaction by interaction capability and also highlights the next UI element. Also end signal button interaction can be assigned to one or more UI element(s) and UI element interaction(s).

In the preferred embodiment, focus behavior can be adjusted by UG programming; hence during implementation of the UG file, desired UI element can be focused at desired step by the interaction capability of the UG application.

In the preferred embodiment, UG application can include a capability for automatically deleting unnecessary step(s) in the UG file.

In the preferred embodiment, according to UG file, UG application can check for certain conditions and execute the appropriate route. For example implementation of UG file for filling a form can differ according to time parameter (whether it is weekday or weekend).

Computer program product that implements the method of UG file generation 400 of the present invention are also provided with the invention.

### Details of Implementation

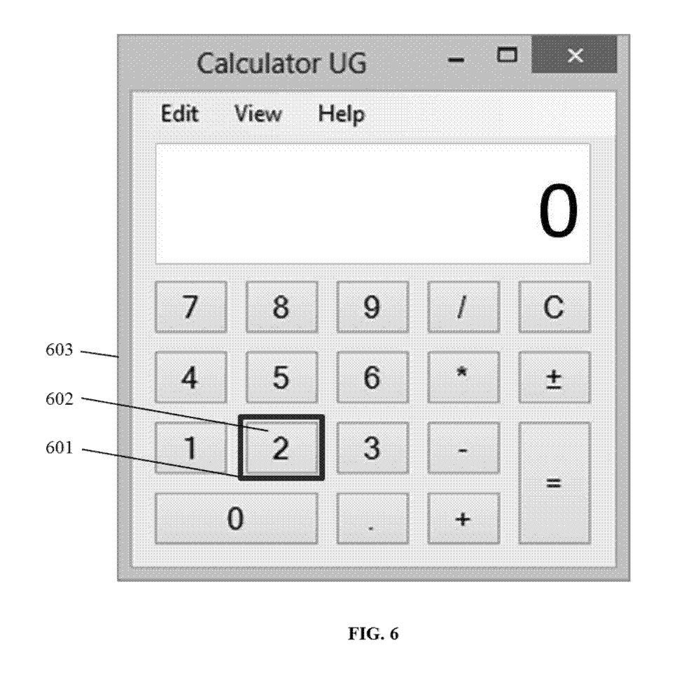

FIG. 5 shows a sample detailed flow diagram of UG file implementation 500.

In the preferred embodiment, implementation includes all features for implementing UG file for achieving any task desired with the available application(s). In other embodiments implementation features can be limited.

User opens UG application 501 by clicking the icon on the desktop of the application. UI of the UG application opens.

In the preferred embodiment, user can search 502 sources (e.g. local/UG Store/other) for UG file for the desired task (e.g. signing up to Gmail) by writing the task into search textbox and click search button. After that search results listed on the list box. User selects the appropriate UG file and opens 503 by double click. While opening, UG application reads all the data in the UG file, shows the steps in another list box in a human readable format and prepares to implement the UG file. When user clicks play button, UG application starts playing (implementing) 504 UG file, UI of the UG application minimizes 505 to bottom of the OS UI to guide the user without any obstructions. UG file can contain one or more steps 506. If the UI element that the user will interact is recognized 507 by UG application then the UI element that user will interact is highlighted 508.

In the preferred embodiment, highlighting can be done by drawing a thick outline to the UI element. In other embodiments highlighting methods such as changing the color of the UI element that user interact, implementing animations, etc. may be applied. Highlighting is the core feature of the present invention.

In the preferred embodiment, UI element interaction information can be given 508 by different highlight colors for different kind of interactions (red highlight means left click, green highlight means right click, etc.) instead of text. Colors can be adjusted for color blind people. For keyboard interactions showing symbol or letter can be preferred (“ghost letter G” means “press G key”, etc.). In other embodiments UI element interaction information may be given as text attached to the highlight, may be shown in a fixed location or variable location or may not be shown. UI element interaction information can be given as animation, etc. in some other embodiments.

In the preferred embodiment, further information can be given 508 attached to the highlight. In other embodiments it may be shown in a fixed location or variable location or may not be shown.

In the preferred embodiment, if user interacted with UI element as defined 509 in the UG file, UG application recognizes 510 this by recognition capability and highlight and all information given by UG application is cleared 511. If the step is not the last step, UG application moves to the next step. This means that steps 507, 508, 509, 510 and 511 can be repeated for “any number” times in an embodiment of the invention during the execution of UG file implementation 500.

After the execution of the last step UG file ends 512. When the file ends, in the preferred embodiment, a message box pops out to give a feedback to user about the end of UG file is reached and user is asked whether the user would like to maximize UI of UG application for achieving task(s) again or would like to close the UG application 513. In other embodiments, UI of UG application can automatically maximize and can give a feedback to the user about the end of UG file is reached, etc.

User can use UG application for achieving task(s) again or close the UG application 513.

As the main philosophy of the present invention is guiding the user in a user friendly way, if the user doesn't interact with correct UI element and/or with correct UI Interaction as informed, in the preferred embodiment, a message box pops out to give a feedback to user about the error and the user is asked whether the user would like to continue UG file implementation, would like to stop UG file implementation and maximize UG application UI or would like to close the UG application (this also stops UG file implementation). In an embodiment of the invention, said message box does not allow user to do anything other than responding the dialog.

In one embodiment of the invention, while checking if the user has interacted with correct UI element and/or with correct UI Interaction as informed, UG application intercepts the interactions of the user with interface and after determining the UI interaction is correct or not, it lets the action or pops a message box out.

Also user can anytime maximize UG application UI to stop/pause UG file implementation and/or close UG application.

In the preferred embodiment, during implementation, if the highlighted UI element (and UI element interaction information and further information) is not visible, UG application can scroll the screen to make it visible. If there are multiple highlighted UI elements (and UI element interaction information and further information) that cannot be visible at the same time, UG application can scroll the screen periodically to make them visible for a certain amount of time so all of them can be seen. In other embodiments UG application can guide the user to make them visible, etc.

In the preferred embodiment, during implementation, UG application tries to find the UI element in a certain amount of time by using recognition capabilities and if the UI element that will be interacted is not available; in the preferred embodiment, UG Application warns the user about the situation (such as UI element, UI element container or application is not available), offers a solution, lets user to make changes and asks if the user would like to try again to continue. In other embodiments, UG application can automatically make UI element that will be interacted available (by opening a toolbar, download or upgrade the related application, etc.) or guide the user to make them available, etc.

In the preferred embodiment, UG application can employ mechanisms for exception handling. For example an exception (unexpected window, error window, etc.) can be recognized by recognition capabilities and UG application may wait the user to solve that exception and after that continues implementation. In other embodiments, UG application may include libraries of exceptions and guides the user on these exception situations or there may not be any exception handling mechanisms, etc.

In the preferred embodiment, during implementation, UG application can remember where left off (at restart situations, etc.).

In the preferred embodiment, during implementation, UG file name is written on the title bar of the UG application UI for the user to see.

Computer program product that implements the method of UG file implementation 500 of the present invention is also provided with the invention.

In FIGS. 6-8 some steps of implementation of UG application for a very basic task “Addition of 2 with 3” on a calculator application is shown as a sample. In this example highlight shows UI element that will be interacted, highlight color red (color black in figures) gives UI element interaction information “left click”.

After user presses play button on UG application, UI of UG application minimizes and UG application recognizes and highlights 601 “button 2” 602 on calculator application 603 as in FIG. 6. After user left clicks “button 2” 602 and UG application recognizes “button 2” 602 is left clicked, highlight 601 on “button 2” 602 is cleared.

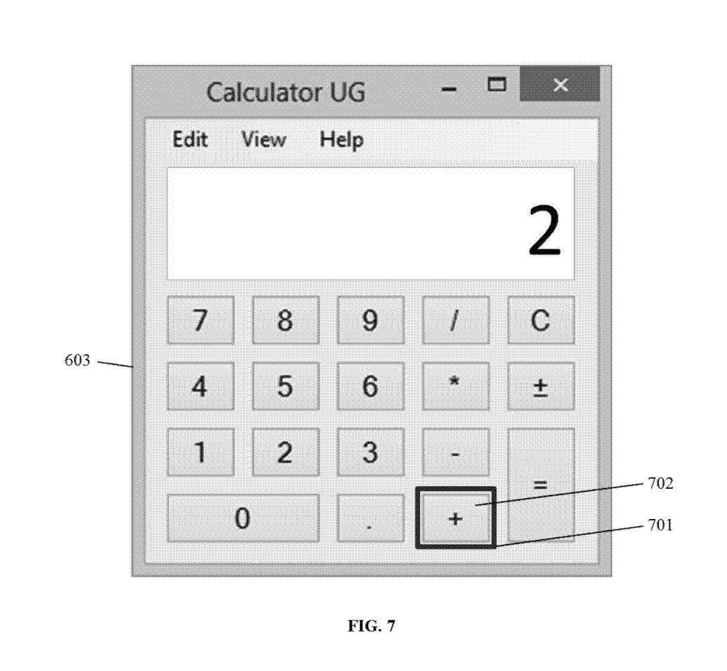

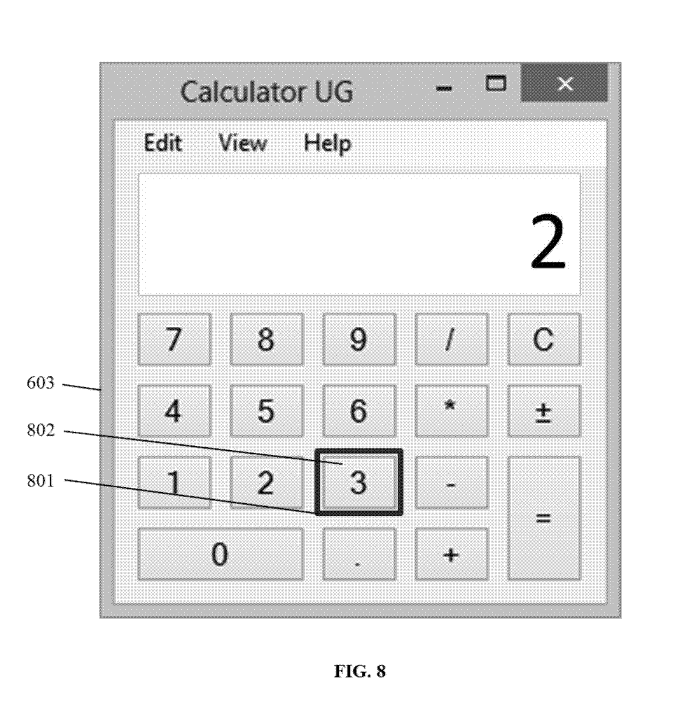

UG application recognizes and highlights 701 “button +” 702 on calculator application 603 as in FIG. 7. After user left clicks “button +” 702 and UG application recognizes “button +” 702 is left clicked, highlight 701 on “button +” 702 is cleared.

UG application recognizes and highlights 801 “button 3” 802 on calculator application 603 as in FIG. 8 and the guidance goes on.

While the present invention has been fully described above with particularly and detail in connection with what is presently deemed to be the most practical and preferred embodiment(s) of the invention, it will be apparent to those of ordinary skill in the art that numerous modifications, including but not limited to, variations in function and manner of operation, assembly and use may be made, without departing from the principles and concepts of the invention as set forth in the claims.

We claim:

1. A method for guiding a user, in a user centered way, to let the user achieve a task while using one or more software, the method comprising:
understanding task that should be achieved,
generating User Guidance (UG) file,
outputting UG file.

2. The method of claim 1, wherein outputting UG file step comprises outputting a data file that includes User Interface (UI) element and UI element interaction information and further information.

3. The method of claim 1, wherein outputting UG file step comprises outputting an executable file that is implemented directly on the operating system.

4. The method of claim 1, wherein generating UG file step comprises outputting more than one file with batch processing.

5. The method of claim 2, wherein outputting UG file step comprises outputting a UG file that is in the form of XML format.

6. The method of claim 1, wherein outputting UG file step comprises outputting UG data that is allocated in the memory of the computing device on which UG application runs.

7. A method for guiding a user, in a user centered way, to let the user achieve a task while using one or more software, the method comprising:
taking UG file as the input,
implementing UG file,
achieving the task by following the guidance.

8. The method of claim 7, wherein taking UG file as the input step comprises taking UG file from a local source.

9. The method of claim 7, wherein taking UG file as the input step comprises taking UG file from a remote source.

10. The method of claim 7, wherein implementing UG file step comprises implementing more than one UG file serially.

11. The method of claim 7, wherein achieving the task by following the guidance step comprises the user performing the task according to UG file by following highlighted UI element(s), UI element interaction information which is for explaining the required action that will be executed on the highlighted UI element and further information which is for explaining the meaning of the step and which can be any type of data.

12. A method for guiding a user, in a user centered way, to let the user achieve a task while using one or more software, the method comprising:
opening UG application,
starting recording process,
UG application minimizing,
user interacting with UI elements of software applications and/or operating system,
recognizing UI element and UI element interaction,
recording UI element and UI element interaction,
stopping the recording process,
editing the recording,
saving UG file,
closing UG application.

13. The method of claim 12, wherein opening UG application step comprises opening UI of the UG application.

14. The method of claim 12, wherein starting recording process step comprises starting the recording of UI element and UI element interaction information.

15. The method of claim 14, wherein the recording UI element and UI element interaction information is conducted by using the capabilities of a UI Automation framework used in UG application.

16. The method of claim 12, wherein recording UI element and UI element interaction step comprises listing recorded UI elements and UI element interactions data as steps in a list box of the UG application during recording.

17. The method of claim 12, wherein recording UI element and UI element interaction step comprises listing recorded UI elements and UI element interactions data as steps in a list box of the UG application after recording has finished.

18. The method of claim 12, wherein user interacting with UI elements of software applications and/or operating system, recognizing UI element and UI element interaction and recording UI element and UI element interaction steps can be repeated for “any number” times.

19. The method of claim 12, wherein editing the recording step means using UG Programming capability of UG application.

20. The method of claim 19, wherein all programming basics; sequence or carrying out a process, iteration or looping, selection or decision taking are all accomplished by using UG programming.

21. The method of claim 20, wherein one or more loops accomplished by UG programming can be terminated by one or more end signals.

22. The method of claim 19, wherein using UG programming is conducted by a GUI for programming.

23. The method of claim 19, wherein using UG programming is conducted by an editor.

24. The method of claim 19, wherein using UG programming means to add, change or delete the whole of and/or UI Element and/or UI Element Interaction and/or further information of a step.

25. The method of claim 19, wherein using UG programming means to determine the order of the steps.

26. The method of claim 12, wherein recognizing UI element and UI element interaction and recording UI element and UI element interaction steps comprise recognizing and recording the interactions with UI element(s) on software and/or hardware.

27. The method of claim 19, wherein using UG programming means to edit UG file so that it includes different guidance routes (branches) that can be added to any place of the flow(s).

28. The method of claim 19, wherein using UG programming means to combine UG files as branches or sequentially to form UG assemblies which are also UG files.

29. The method of claim 19, wherein using UG programming means to select some or all of the steps and mark the as steps to be automated.

30. The method of claim 19, wherein using UG programming means to assign UI element and UI element interaction to one or more UI element(s) and UI element interaction(s) as related to the interaction capability of UG application.

31. A method for guiding a user, in a user centered way, to let the user achieve a task while using one or more software, the method comprising:
opening UG application,
searching the UG file,
selecting and opening UG file,
starting playing the UG file,
UG application minimizing,
recognizing UI element,
indicating the guidance information,
user interacting with UI element,
recognizing UI element interaction,
clearing the guidance information from screen,
ending UG file,
closing the UG application.

32. The method of claim 31, wherein selecting and opening UG file step comprises UG application reading all the data in the UG file and showing the steps in a list box in a human readable format.

33. The method of claim 31, wherein indicating the guidance information step comprises highlighting the UI element that the user will interact.

34. The method of claim 33, wherein indicating the guidance information step further comprises providing UI element interaction information by different highlight colors for different kind of interactions.

35. The method of claim 34, wherein indicating the guidance information step further comprises providing further information as attached to the highlight.

36. The method of claim 31, wherein user interacting with UI element step comprises guiding the user with a message box that pops out, if the user doesn't interact with correct UI element and/or with correct UI Interaction as informed.

37. The method of claim 31, wherein user interacting with UI element step further comprises guiding the user with a message box which does not allow user to do anything other than responding the dialog, if the user doesn't interact with correct UI element and/or with correct UI Interaction as informed.

38. The method of claim 31, wherein recognizing UI element step comprises employing mechanisms for exception handling.

39. The method of claim 31, wherein recognizing UI element, indicating the guidance information, user interacting with UI element, recognizing UI element interaction and clearing the guidance information from screen steps can be repeated for “any number” times.

40. A system for guiding a user, in a user centered way, to let the user achieve a task while using one or more software application, the system comprising:
a User Guidance (UG) application that allows user to generate and/or implement user guidance instructions,
UG files that stores the data related to user guidance instructions generated and/or implemented by UG application,
a local source that is accessed by UG application and stores the UG files,
a client on which the UG application runs, local sources and necessary hardware to run UG application and interact with user exist,
a store server system that contains servers and databases, interacts with client over a network to let client download UG files from it and upload UG files to it, and keeps UG files and provide search results if the user chooses to search UG files in the store server system via UG application,
a remote source that interacts with client over a network to let client download UG files from it,
operating system on which the UG application runs and interacts with UG application for generation and implementation of UG files,
at least one software application for which UG files are generated and implemented by UG application and that interacts with UG application via its UI elements.

41. The system of claim 40, wherein a UI automation framework is used by UG application.

42. The system of claim 40, wherein UG application contains a UI that comprises a menu bar which contains File, Edit, Insert, Format, Help menus, a search textbox and search button, record, play and stop buttons, a list box for listing search results, another list box for showing information about the steps of the UG file.

43. The system of claim 40, wherein UG application discovers, identifies and recognizes UI element and UI element interactions and perform UI element interactions.

44. A computer program product for guiding a user, in a user centered way, to let the user achieve a task while using a software application, the computer program comprising:
computer readable code for opening UG application, starting recording process, UG application minimizing, user interacting with UI elements of software applications and/or operating system, recognizing UI element and UI element interaction, recording UI element and UI element interaction, stopping the recording process, editing the recording, saving UG file, closing UG application,
computer readable code for opening UG application, searching the UG file, selecting and opening UG file, starting playing the UG file, UG application minimizing, recognizing UI element, indicating the guidance information, user interacting with UI element, recognizing UI element interaction, clearing the guidance information from screen, ending UG file, closing the UG application.
